(19) United States
(12) Patent Application Publication
(10) Pub. No.: US 2014/0364515 A1
(43) Pub. Date: Dec. 11, 2014

(54) Silicone Foam Control Compositions And Process For Making Thereof

(71) Applicants: Jianren Zeng, Chiba-shi (JP); Serge Creutz, Liege (BE); Masakado Kennoki, Chiba (JP)

(72) Inventors: Jianren Zeng, Chiba-shi (JP); Serge Creutz, Liege (BE); Masakado Kennoki, Chiba (JP)

(73) Assignee: Dow Corning Corporation, Midland, MI (US)

(21) Appl. No.: 14/345,466

(22) PCT Filed: Sep. 14, 2012
(86) PCT No.: PCT/US12/55395

§ 371 Date: Aug. 25, 2014

Related U.S. Application Data
(60) Provisional application No. 61/536,178, filed on Sep. 19, 2011.

(51) Int. Cl. B01D 19/04

(52) U.S. Cl. CPC B01D 19/0413
USPC 516/55; 516/123

(57) ABSTRACT

A silicone foam control composition comprises a finely divided filler, an organosilicon compound that contains at least two silicon-bonded hydroxy groups in each molecule, an organosilicon compound having at least two silicon-bonded aminoxy groups in each molecule, and optionally an inert fluid. At least (B) and (C) react so the silicone foam control composition has a viscosity of from 1,000 mPa·s to 1,000,000 mPa·s at 25° C. An oil-in-water silicone emulsion composition comprising the silicone foam control composition, a process for making the silicone foam control composition, and a method of using the composition, are also disclosed.

### CROSS REFERENCE TO RELATED APPLICATIONS

This application claims the benefit of U.S. Provisional Patent Application Ser. No. 61/536,178, filed on 19 Sep. 2011, under 35 U.S.C. §119(e). U.S. Provisional Patent Application Ser. No. 61/536,178 is hereby incorporated by reference

### FIELD OF THE INVENTION

Disclosed herein are silicone foam control compositions and a process for making foam control compositions, especially compositions which are of use in aqueous media, such as the paper making and pulping process, textile dyeing process, inks, coatings, paints, detergents, waste water treatment, the scrubbing of natural gas and metal working process.

### BACKGROUND OF THE INVENTION

Foam control compositions for pulping processes have been known and used for some time and have been described in a number of publications. A very important type of such pulping foam control compositions are based on silicone materials.

### SUMMARY OF THE INVENTION

Foam generates widespread problems in all too many manufacturing processes, and can impose severe limitations on the efficient use of equipment. Additionally, the problems are aggravated in some cases by the development of new, high-speed processes. The need for maximum production at times of peak demand can often be frustrated by a disproportionate generation of foam. The foaming in aqueous media, such as the paper making and pulping process, textile dyeing process, inks, coatings, paints, detergents, waste water treatment, the scrubbing of natural gas and metal working process is reduced by the composition of the present invention.

The present invention relates to a silicone foam control composition comprising;

(A) a finely divided filler, and

(B) an organosilicon compound having at least two silicon-bonded hydroxy groups in each molecule capable of reaction with,

(C) an organosilicon compound having at least two silicon-bonded aminoxy groups in each molecule wherein the molar ratio of (B):(C) is 100:1 to 1:100, and optionally

(D) an inert fluid,

wherein at least (B) and (C) react so the silicone foam control composition has a viscosity of from 1,000 mPa-S to 1,000,000 mPa-S at 25° C.

The present invention also relates to a silicone foam control composition comprising

(A) a finely divided filler, and

(B) an organosilicon compound having at least two silicon-bonded hydroxy groups in each molecule,

(C) an organosilicon compound having at least two silicon-bonded aminoxy groups in each molecule wherein the molar ratio of silanol groups in (B) to aminoxy groups in (C) is 100:1 to 1:100, and optionally

(D) an inert fluid,

wherein at least (B) and (C) react so the silicone foam control composition has a viscosity of from 1,000 mPa-S to 1,000,000 mPa-S at 25° C.

Also disclosed herein is an oil-in-water silicone emulsion comprising:

water and dispersed therein a silicone foam control composition comprising components (A), (B), (C), and optionally (D) as disclosed above.

Also disclosed herein is a method for controlling foam in an aqueous media comprising adding a sufficient amount of a silicon foam control composition comprising components (A), (B), (C), and optionally (D) as described above, to the aqueous media.

Further disclosed herein is a process for making a foam control composition comprising the steps of mixing (A) a finely divided filler, and (B) an organosilicon compound having at least two silicon-bonded hydroxy groups in each molecule, capable of reaction with (C) an organosilicon compound having at least two silicon-bonded aminoxy groups in each molecule wherein the reaction is conducted until the reaction mixture leads to a significant viscosity increase of at least 5-fold, while still being flowable, or the reaction products are emulsified and the reaction occurs within the emulsion wherein the molar ratio of (B):(C) is 100:1 to 1:100, and optionally (D) an inert fluid.

Further disclosed herein is a process for making a foam control composition comprising the steps of mixing (A) a finely divided filler, and (B) an organosilicon compound having at least two silicon-bonded hydroxy groups in each molecule, (C) an organosilicon compound having at least two silicon-bonded aminoxy groups in each molecule wherein the molar ratio of silanol groups in (B) to aminoxy groups in (C) is 100:1 to 1:100, and optionally (D) an inert fluid, and allowing at least (B) and (C) to react so the silicone foam control composition has a viscosity of from 1,000 mPa-S to 1,000,000 mPa-S at 25° C.

In the above embodiments, the lower limit of the viscosity of the reaction product of component (B) with component (C) in the presence of component (A) and optionally component (D) is 1,000 mPa-S and alternatively 5,000 mPa-S. The upper limit of the viscosity of the reaction product of component (B) with component (C) in the presence of component (A) and optionally component (D) is 1,000,000 mPa-S, alternatively 500,000 mPa-S, and alternatively 100,000 mPa-S at 25° C.

### DETAILED DESCRIPTION OF THE INVENTION

All amounts, ratios, and percentages are by weight unless otherwise indicated. The following is a list of definitions as used in this application.

### DEFINITIONS

The terms “a” and “an” each mean one or more.

The abbreviation “M” means a siloxane unit of formula R₃SiO_{1/2}, where each R independently represents a monovalent atom or group.

The abbreviation “D” means a siloxane unit of formula R₂SiO_{2/2}, where each R independently represents a monovalent atom or group.

The abbreviation “T” means a siloxane unit of formula RSiO_{3/2}, where R represents a monovalent atom or group.

The abbreviation “Q” means a siloxane unit of formula SiO_{4/2}.

The abbreviation “Me” represents a methyl group.

The term “dispersion” means one phase of matter that is immiscible with and dispersed in another phase of matter.

The term “emulsion” means one phase of matter that is dispersed in another phase and further contains an emulsifying agent.

Generally, the silicone foam control composition includes a finely divided filler, an organosilicon compound containing silicon-bonded hydroxy groups in each molecule (silanol groups), and an aminoxy group-containing organosilicon compound. The silicone foam control composition optionally contains a polydiorganosiloxane fluid.

### (A) The Finely Divided Filler

The finely divided filler (A) is a finely divided particulate material. It may be any of the known inorganic fillers suitable for formulating foam control compositions. Such fillers are described in many patent applications and are commercially available. They include fumed TiO₂, Al₂O₃, aluminosilicates, zinc oxide, magnesium oxide, salts of aliphatic carboxylic acids, polyethylene wax, reaction products of isocyanates with certain materials, e.g. cyclohexylamine, alkyl amides, e.g. ethylene or methylene bis stearamide and SiO₂ with a surface area as measured by BET measurement of at least 50 m²/g. Alternative fillers are silica fillers which can be made according to any of the standard manufacturing techniques for example thermal decomposition of a silicon halide, a decomposition and precipitation of a metal salt of silicic acid, e.g. sodium silicate and a gel formation method. Alternatively, the silica is a precipitated silica or a gel formation silica, alternatively precipitated silica. The average particle size of these fillers may range from 0.1 to 50 μm, alternatively from 0.1 to μm 20, and alternatively from 0.5 to 2.0 μm.

The surface of finely divided filler particles may be hydrophilic or hydrophobic in order to make the foam control composition sufficiently effective in aqueous systems. Alternatively, the filler particles are hydrophobic particles. Where they are not naturally hydrophobic, the filler particles may be rendered hydrophobic. This can be effected by treatment of the filler particles with treating agents, e.g. fatty acids, reactive silanes or siloxanes, for example stearic acid, dimethyldichlorosilane, trimethylchlorosilane, hexamethyldisilazane, hydroxy-endblocked and methyl-endblocked polydimethylsiloxanes and siloxane resins. Fillers which have already been treated with such compounds are commercially available from many companies, for example Sipernat® D10 from Degussa. Alternatively, the filler particles are hydrophilic particles.

### (B) Hydroxy Containing Organosilicon Compound

Organosilicon compound (B) is a polyorganosiloxane that contains at least two silicon-bonded hydroxy groups in each molecule. The at least two hydroxy groups may both be internal or terminal, or one hydroxy group is terminal and the other hydroxy group is internal. Alternatively, organosilicon compound (B) is a polyorganosiloxane that contains on average at least two hydroxy groups in each molecule, alternatively on average at least three hydroxy groups in each molecule. Alternatively, Component (B) is selected from the general formulae (Ia) or (Ib) or a mixture thereof

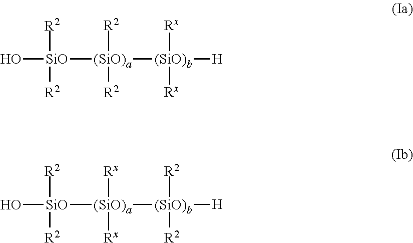

wherein each R² is independently selected from a hydroxy group, an alkyl group having from 1 to 18 carbon atoms, an alkenyl group having from 2 to 18 carbon atoms, an alkynyl group having from 2 to 18 carbon atoms, an aryl group having from 6 to 10 carbon atoms, an alkoxy group of the formula —OR³ wherein R³ is an alkyl group having from 1 to 18 carbon atoms, an X-Ph group wherein X denotes-R^{y}—, —R^{y}—O—, —R^{y}—O—R^{y}—, or —COO— wherein R^{y} is an alkylene group and contains from 1 to 18 carbon atoms, and Ph is a phenyl group or a phenyl group substituted with one or more methyl, methoxy, hydroxy, or chloro groups, and a group of the formula —R^{a}O(C₂H₄O)ₓ—(C₃H₆O)_{y}—(C₄H₈O)_{z}R^{b} wherein R^{a} is an alkylene group containing from 1 to 18 carbon atoms, R^{b} is a hydrogen atom, an alkyl group containing from 1 to 6 carbon atoms, or an acyl group containing from 1 to 6 carbon atoms, x is 0-50, y is 0-50, and z is 0-20, with the proviso that x+y+z is ≧1, and wherein each R^{x} is independently selected from a hydroxyl group, an alkyl group having from 1 to 18 carbon atoms, or a group of the general formula (II)

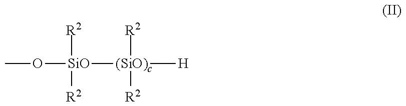

wherein R² is defined above, and a, b, and c have a value of zero or greater, provided that at least one of a and b is ≧1, and the total of a+b+c is from 1 to 10,000, alternatively 1 to 100.

Alternatively, Component (B) is represented by general formulae (Ia) and (Ib) as described above.

Alternatively the X-Ph group is 2-phenylpropyl —CH₂—CH(CH₃)—C₆H₅.

Representative non-limiting examples of R², R³, and R⁵ as C₁₋₁₈ alkyl groups are methyl, ethyl, n-propyl, isopropyl, butyl, t-butyl, hexyl, octyl, decyl, and so forth. Alternatively, R² is methyl. Alternatively, R³ is methyl. Alternatively, R⁵ is methyl. Representative non-limiting examples of R², R³, and R⁵ as the C₂₋₁₈ alkenyl groups are vinyl, allyl, the isomeric butenyls, 5-hexenyl, 9-decenyl, and so forth. Representative non-limiting examples of R², R³, and R⁵ as the C₂₋₁₈ alkynyl groups are ethynyl, propynyl, the isomeric butynyls, the isomeric pentynyls, and so forth. Representative non-limiting examples of R², R³, and R⁵ as the aryl groups are phenyl, tolyl, xylyl, and so forth. Alternatively, R² is phenyl. Alternatively, R³ is phenyl. Alternatively, R⁵ is phenyl. Representative non-limiting examples of R⁴ as the alkylene groups are methylene, ethylene, the isomeric propylenes, the isomeric butylenes, the isomeric pentylenes, the isomeric hexylenes, phenylene, and so forth. Alternatively, R⁴ is methylene. Alternatively, R⁴ is phenylene. Alternatively, R² is a group of the formula —R^{a}O(C₂H₄O)ₓ—(C₃H₆O)_{y}—(C₄H₈O)_{z}R^{b} wherein R^{a} is an alkylene group containing from 1 to 18 carbon atoms, R^{b} is a hydrogen atom, an alkyl group containing from 1 to 6 carbon atoms, or an acyl group containing from 1 to 6 carbon atoms, x is 0-50, y is 0-50, and z is 0-20, with the proviso that x+y+z is ≧1.

### (C) Aminoxy Group-Containing Organosilicon Compound

Organosilicon compound (C) is an organosilicon compound that contains at least two aminoxy groups. Alternatively, (C) is an organosilicon compound that contains on average at least two aminoxy groups in each molecule, alternatively on average at least three aminoxy groups in each molecule. Alternatively, (C) is selected from the general formulae (III) or (IV) or a mixture thereof

R⁶₄₋ₘSi(ONR⁷2)ₘ (III)

R⁹R⁸₂SiO(R⁹₂SiO)ₙ(R⁸₂SiO)_{m′}SiR⁸₂R⁹ (IV)

wherein R⁶ is selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and —ONR⁷₂, wherein R⁷ is independently an alkyl group having from 1 to 4 carbon atoms, and m is from 1 to 4; each R⁸ is independently selected from an alkyl group having from 1 to 18 carbon atoms, an alkenyl group having from 2 to 18 carbon atoms, an alkynyl group having from 2 to 18 carbon atoms, and an aryl group having from 6 to 10 carbon atoms, each R⁹ is independently selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and an aminoxy group of the formula —ONR¹⁰₂, with the proviso that at least two R⁹ groups are aminoxy groups, n is ≧1, and m′ is ≧0.

Representative non-limiting examples of R⁶, R⁸, and R⁹ as C₁₋₁₀ alkyl groups are methyl, ethyl, n-propyl, isopropyl, butyl, t-butyl, hexyl, octyl, decyl, and so forth. Alternatively, R⁶ is methyl. Alternatively, R⁸ is methyl. Alternatively, R⁹ is methyl. Representative non-limiting examples of R⁶, R⁸, and R⁹ as the C₂₋₁₀ alkenyl groups are vinyl, allyl, the isomeric butenyls, 5-hexenyl, 9-decenyl, and so forth. Representative non-limiting examples of R⁶, R⁸, and R⁹ as the C₂₋₁₀ alkynyl groups are ethynyl, propynyl, the isomeric butynyls, the isomeric pentynyls, and so forth. Representative non-limiting examples of R⁶, R⁸, and R⁹ as the aryl groups are phenyl, tolyl, xylyl, and so forth. Alternatively, R⁶ is phenyl. Alternatively, R⁸ is phenyl. Alternatively, R⁸ is a group of the formula —R^{a}O(C₂H₄O)ₓ—(C₃H₆O)_{y}—(C₄H₈O)_{z}R^{b} wherein R^{a} is an alkylene group containing from 1 to 18 carbon atoms, R^{b} is a hydrogen atom, an alkyl group containing from 1 to 6 carbon atoms, or an acyl group containing from 1 to 6 carbon atoms, x is 0-50, y is 0-50, and z is 0-20, with the proviso that x+y+z is ≧1. Alternatively, R⁹ is phenyl. Representative non-limiting examples of R⁷ and R¹⁰ as the C₁₋₄ alkyl groups are methyl, ethyl, n-propyl, isopropyl, and the isomeric butyls. In an alternative embodiment, R⁸ may be an X-Ph, as defined above.

### (D) The Inert Fluid

The inert fluid is an optional component. It is to be understood that the term “inert fluid” is intended to mean a substantially non-volatile fluid. Further, the inert fluid does not react with (B) or (C), the reaction product of (B) and (C), or the by-product of the reaction of (B) and (C). The inert fluid is at least one of an inert organopolysiloxane fluid or an organic fluid.

The inert organopolysiloxane fluid may comprise trialkylsilyl-terminated polydiorganosiloxane and derivatives thereof which may comprise a degree of substitution, with the proviso that any substituted groups do not participate in any reactions with other components or their by-products. The alkyl groups may be the same or different and have from 1 to 18 carbon atoms and alternatively from 1 to 8 carbon atoms. Alternatively, the alkyl groups are methyl or ethyl groups.

The inert fluid may also comprise an inert organic fluid as an extender/organic plasticizer and alternatively mineral oil extenders and plasticisers. Examples include linear or branched mono unsaturated hydrocarbons such as linear or branched alkenes or mixtures thereof containing at least 12, e.g. from 12 to 25 carbon atoms; and/or mineral oil fractions comprising linear (e.g. n-paraffinic) mineral oils, branched (iso-paraffinic) mineral oils, cyclic (referred in some prior art as naphthenic) mineral oils and mixtures thereof. The hydrocarbons utilized comprise at least 10, alternatively at least 12 and alternatively greater than 20 carbon atoms per molecule.

Other mineral oil extenders include alkylcycloaliphatic compounds, low molecular weight polyisobutylenes, phosphate esters, and alkybenzenes including polyalkylbenzenes.

Any suitable mixture of mineral oil fractions may be utilized as the inert fluid. Examples include:—alkylcyclohexanes (molecular weight >220); paraffinic hydrocarbons and mixtures thereof containing from 1 to 99%, alternatively from 15 to 80% n-paraffinic and/or isoparaffinic hydrocarbons (linear branched paraffinic) and 1 to 99%, alternatively 85 to 20% cyclic hydrocarbons (naphthenic) and a maximum of 3%, alternatively a maximum of 1% aromatic carbon atoms. The cyclic paraffinic hydrocarbons (naphthenics) may contain cyclic and/or polycyclic hydrocarbons. Any suitable mixture of mineral oil fractions may be used, e.g. mixtures containing

(i) 60 to 80% paraffinic and 20 to 40% naphthenic and a maximum of 1% aromatic carbon atoms;

(ii) 30-50%, alternatively 35 to 45% naphthenic and 70 to 50% paraffinic and or isoparaffinic oils;

(iii) hydrocarbon fluids containing more than 60 wt. % naphthenics, at least 20 wt. % polycyclic naphthenics and an ASTM D-86 boiling point of greater than 235° C.;

(iv) hydrocarbon fluid having greater than 40 parts by weight naphthenic hydrocarbons and less than 60 parts by weight paraffinic and/or isoparaffinic hydrocarbons based on 100 parts by weight of hydrocarbons.

Alternatively the mineral oil based extender or mixture thereof comprises at least one of the following parameters:—

(i) a molecular weight of greater than 150, alternatively greater than 200; an initial boiling point equal to or greater than 230° C. (according to ASTM D 86);

(ii) a viscosity density constant value of less than or equal to 0.9; (according to ASTM 2501);

(iii) an average of at least 12 carbon atoms per molecule, alternatively 12 to 30 carbon atoms per molecule;

(iv) an aniline point equal to or greater than 70° C., alternatively the aniline point is from 80 to 110° C. (according to ASTM D 611);

(v) a naphthenic content of from 20 to 70% by weight of the extender and a mineral oil based extender has a paraffinic content of from 30 to 80% by weight of the extender according to ASTM D 3238);

(vi) a pour point of from −50 to 60° C. (according to ASTM D 97);

(vii) a kinematic viscosity of from 1 to 20 cSt at 40° C. (according to ASTM D 445);

(viii) a specific gravity of from 0.7 to 1.1 (according to ASTM D1298);

(ix) a refractive index of from 1.1 to 1.8.at 20° C. (according to ASTM D 1218);

(x) a density at 15° C. of greater than 700 kg/m³ (according to ASTM D4052); and/or

(xi) a flash point of greater than 100° C., alternatively greater than 110° C. (according to ASTM D 93);

(xii) a saybolt color of at least +30 (according to ASTM D 156);

(xiii) a water content of less than or equal to 250 ppm;

(xiv) a sulfur content of less than 2.5 parts per million (according to ASTM D 4927).

Other organic extenders may include for the sake of example, fatty acid esters, alkylbenzene compounds suitable for use include heavy alkylate alkylbenzene or an alkylcycloaliphatic compound. Examples of alkyl substituted aryl compounds useful as extenders and/or plasticisers are compounds which have aryl groups, especially benzene substituted by alkyl and possibly other substituents, and a molecular weight of at least 200.

The alkylbenzene compounds suitable for use include heavy alkylate alkylbenzene or an alkylcycloaliphatic compound. Examples of alkyl substituted aryl compounds useful as extenders and/or plasticisers are compounds which have aryl groups, especially benzene substituted by alkyl and possibly other substituents, and a molecular weight of at least 200. Examples of such extenders are described in U.S. Pat. No. 4,312,801, the content of which is incorporated herein by reference. These compounds can be represented by general formula (V), (VI), (VII) and (VIII)

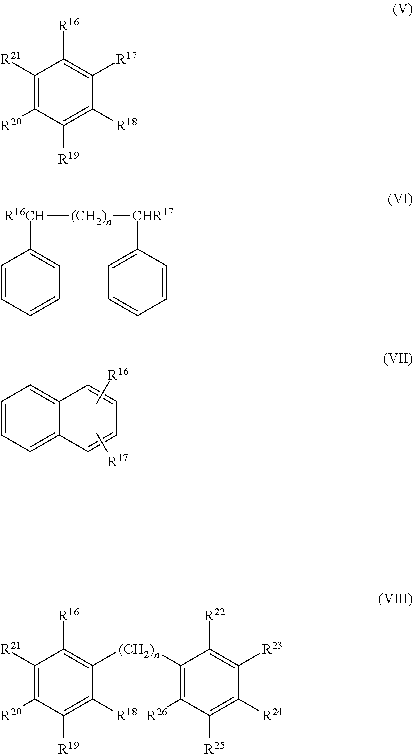

where R¹⁶ is an alkyl chain of from 1 to 30 carbon atoms, each of R¹⁷ through to R²⁶ is independently selected from hydrogen, alkyl, alkenyl, alkynyl, halogen, haloalkyl, nitrile, amide, an ether such as an alkyl ether or an ester such as an alkyl ester group, and n is an integer of from 1 to 25. Of these compounds of formula (VI) where each of R¹⁷, R¹⁸, R¹⁹, R²⁰ and R²¹ is hydrogen and R¹⁶ is a C₁₀-C₁₃ alkyl group are preferred. A particularly useful source of such compounds are the so-called “heavy alkylates”, which are recoverable from oil refineries after oil distillation. Generally distillation takes place at temperatures in the range of from 230 to 330° C., and the heavy alkylates are present in the fraction remaining after the lighter fractions have been distilled off.

Examples of alkylcycloaliphatic compounds are substituted cyclohexanes with a molecular weight in excess of 220. Examples of such compounds are described in EP 0842974, the content of which is incorporated herein by reference. Such compounds may be represented by general formula (IX).

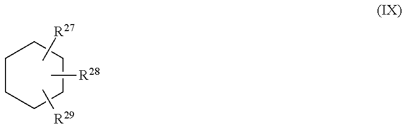

where R²⁷ is a straight or branched alkyl group of from 1 to 25 carbon atoms, and R²⁸ and R²⁹ are independently selected from hydrogen or a C₁₋₂₅ straight or branched chain alkyl group.

Alternatively the inert fluid may comprise may comprise a suitable non-mineral based (i.e. not from petroleum or petroleum based oils) natural oil or a mixture thereof, i.e. those derived from animals, seeds and nuts such as for example almond oil, avocado oil, beef tallow, borrage oil, butterfat, canola oil, cardanol, cashew nut oil, cashew nutshell liquid, castor oil, citrus seed oil, cocoa butter, coconut oil, cod liver oil, corn oil, cottonseed oil, cuphea oil, evening primrose oil, hemp oil, jojoba oil, lard, linseed oil, macadamia oil, menhaden oil, oat oil, olive oil, palm kernel oil, palm oil peanut oil, poppy seed oil, rapeseed oil, rice bran oil, safflower oil, safflower oil (high oleic), sesame oil, soybean oil, sunflower oil, sunflower oil (high oleic), tall oil, tea tree oil, turkey red oil, walnut oil perilla oil, dehydrated castor oils, apricot oil, pine nut oil, kukui nut oil, amazon nut oil almond oil, babasu oil, argan oil, black cumin oil, bearberry oil, calophyllum oil, camelina oil, carrot oil, carthamus oil, cucurbita oil, daisy oil, grape seed oil, foraha oil, jojoba oil, queensland oil, onoethera oil, ricinus oil, tamanu oil, tucuma oil, fish oils such as pilchard, sardine and herring oils. The extender may alternatively comprise mixtures of the above and/or derivatives of one or more of the above.

A wide variety of natural oil derivatives are available. These include transesterified natural vegetable oils, boiled natural oils such as boiled linseed oil, blown natural oils and stand natural oils. An example of a suitable transesterified natural vegetable oil is known as biodiesel oil, the transesterification product produced by reacting mechanically extracted natural vegetable oils from seeds, such as rape, with methanol in the presence of a sodium hydroxide or potassium hydroxide catalyst to produce a range of esters dependent on the feed utilised. Examples might include for example methyloleate CH₃(CH₂)₇CH═CH(CH₂)₇CO₂CH₃.

Stand natural oils which are also known as thermally polymerised or heat polymerised oils and are produced at elevated temperatures in the absence of air. The oil polymerises by cross-linking across the double bonds which are naturally present in the oil. The bonds are of the carbon-carbon type. Stand natural oils are pale coloured and low in acidity. They can be produced with a wider range of viscosities than blown oils and are more stable in viscosity. In general, stand natural oils are produced from linseed oil and soya bean oil but can also be manufactured based on other oils. Stand natural oils are widely used in the surface coatings industry.

Blown oils which are also known as oxidised, thickened and oxidatively polymerized oils and are produced at elevated temperatures by blowing air through the oil. Again the oil polymerizes by cross-linking across the double bonds but in this case there are oxygen molecules incorporated into the cross-linking bond. Peroxide, hydroperoxide and hydroxyl groups are also present. Blown oils may be produced from a wider range of oils than stand natural oils. In general, blown oils are darker in colour and have a higher acidity when compared to stand natural oils. Because of the wide range of raw materials used, blown oils find uses in many diverse industries, for example blown linseed oils are used in the surface coatings industry and blown rapeseed oils are often used in lubricants.

The amount of inert fluid which may be included in the composition will depend upon factors such as the purpose to which the composition is to be put, the molecular weight of the inert fluid(s) concerned etc. Typical compositions may contain up to at least 70% w/w or even 90% w/w inert fluids(s).

Component (C) promotes the formation of a branched or crosslinked polydiorganosiloxane by reaction and crosslinking with component (B), and potentially component (A), the finely divided filler. In the reaction between (B) and (C), a byproduct is formed, for example a dialkylhydroxyamine of R⁷₂N—OH or R¹⁰₂N—OH, is formed, if (C) is of formula (III) or formula (IV). This reaction occurs without benefit of a catalyst.

Component (C) contains at least two aminoxy groups, which aminoxy groups may be terminal or internal. When the aminoxy groups of (C) react with the hydroxy groups of (B), the reaction product is a linear polyorganosiloxane, a branched polyorganosiloxane or a crosslinked polyorganosiloxane.

In the reaction of (B) and (C), it is optional that a solvent or diluent is employed which is the inert fluid (D), discussed above.

In the reaction of (B) and (C), the molar ratio of (B) to (C) is 100:1 to 1:100, alternatively from 30:1 to 1:30, and alternatively from 10:1 to 1:10. Alternatively, the molar ratio of silanol (Si—OH) groups in (B) to aminoxy groups in (C) is 100:1 to 1:100, alternatively from 30:1 to 1:30, and alternatively from 10:1 to 1:10.

The amount of solvent or diluent which can be used may vary widely, and it is preferred that larger amounts of solvent or diluent are used where the branched or cross-linked polyorganosiloxane has itself a higher viscosity. The amounts of solvent or diluent used could be as high as 90% by weight based on the total formulation of the foam control composition, but alternatively from 70 to 80% is used. It is most appropriate to determine the amount and type, including viscosity, of solvent or diluent used by trial and error based on the desired viscosity of the final foam control composition. The latter may vary widely, and is often determined by the application in which it is to be used. A lower viscosity limit for the silicone foam control composition is 1,000 mPa-S and alternatively 5,000 mPa-S. An upper viscosity limit for the silicone foam control composition is 1,000,000 mPa-S, alternatively 500,000 mPa-S, and alternatively 100,000 mPa-S. Viscosity is measured using a viscometer (Model RE 100 by Toki Sangyo Co., Ltd.).

The reaction product from the reaction of (B) and (C) may have a three dimensional structure. For purposes of foam control compositions according to the present invention, the reaction product could have a viscosity of from 10,000 to several million mPa-s at 25° C. It is preferred that the cross-linking density of the resulting reaction product of (B) and (C) is as high as possible as that provides better performance in the foam control applications. However, it is preferred that an elastomer does not form. In order to handle these materials, the amount of solvent or diluent is to be selected such that the final viscosity of the foam control composition is as desired.

Upon combination of components (A), (B), (C), and optionally (D), it may be possible to use the foam control agent in any suitable form, including as a neat form, in diluted form, in the form of a dispersion, or in the form of an emulsion.

As is known in the art, dispersions are, to a certain degree, unstable. Typically, there are three types of dispersion instability including (i) flocculation, where particles of the dispersed phase form clumps in the continuous phase, (ii) creaming, where the particles of the dispersed phase concentrate toward a surface or bottom of the continuous phase, and (iii) breaking and coalescence, where the particles of the dispersed phase coalesce and form a layer of liquid in the continuous phase. The instant dispersion may exhibit one of more of these types of instability.

For most applications, the foam control composition is emulsified, as this helps with dosing and dispersion of the foam control composition in its final application. Emulsions may be obtained by standard (mechanical) emulsification processes in a subsequent step in the process according to the invention. Alternatively emulsification may be obtained by forming an emulsion during the combination of components (A), (B), and (C), followed by the cross-linking reaction being carried out in the emulsion particles. Such process is often referred to as emulsion polymerization process. Suitable surfactants for the emulsification of foam control agents are well known and have been described in a number of publications. In typical emulsions, the continuous phase is water, but some alternative or additional materials may be used, which are compatible with water, such as alcohols or polyoxyalkylenes. The continuous phase is predominantly water and is present in amounts from 30 to 95% by weight of the total weight of the emulsified foam control composition. The components (A), (B), and (C) would normally provide from 5 to 50% by weight of such an emulsion and the surfactants would represent from 1 to 20% by weight.

Suitable surfactants may comprise a nonionic surfactant, a cationic surfactant, an anionic surfactant, an amphoteric surfactant, or a mixture of such surfactants. Alternatively the nonionic surfactants are used. They could be a silicon-atom-containing nonionic emulsifier, but for the emulsification mostly non-silicon containing nonionic emulsifier are used. Suitable nonionic surfactants include sorbitan fatty esters, ethoxylated sorbitan fatty esters, glyceryl esters, fatty acid ethoxylates, alcohol ethoxylates R¹²—(OCH₂CH₂)_{d}OH, particularly fatty alcohol ethoxylates and organosiloxane polyoxyethylene copolymers. Fatty alcohol ethoxylates typically contain the characteristic group —(OCH₂CH₂)_{d}OH which is attached to a monovalent fatty hydrocarbon residue R¹² which contains about eight to about twenty carbon atoms, such as lauryl (C12), cetyl (C16) and stearyl (C18). While the value of “d” may range from 1 to about 100, its value is typically in the range of about 2 to about 40, alternatively 2 to 24. It is sometimes helpful to use a combination of surfactants to aid the emulsification.

Some examples of suitable nonionic surfactants are polyoxyethylene (4) lauryl ether, polyoxyethylene (5) lauryl ether, polyoxyethylene (23) lauryl ether, polyoxyethylene (2) cetyl ether, polyoxyethylene (10) cetyl ether, polyoxyethylene (20) cetyl ether, polyoxyethylene (2) stearyl ether, polyoxyethylene (10) stearyl ether, polyoxyethylene (20) stearyl ether, polyoxyethylene (21) stearyl ether, polyoxyethylene (100) stearyl ether, polyoxyethylene (2) oleyl ether, and polyoxyethylene (10) oleyl ether. These and other fatty alcohol ethoxylates are commercially available under trademarks and tradenames such as ALFONICO, BRIJ, GENAPOL (S), NEODOL, SURFONIC, TERGITOL and TRYCOL. Ethoxylated alkylphenols can also be used, such as ethoxylated octylphenol, sold under the trademark TRITONS.

Cationic surfactants useful in the invention include compounds containing quaternary ammonium hydrophilic moieties in the molecule which are positively charged, such as quaternary ammonium salts represented by R¹³₄N+Y⁻ where each R¹³ are independently alkyl groups containing 1-30 carbon atoms, or alkyl groups derived from tallow, coconut oil, or soy and Y is sulfate, phosphate, or halogen, i.e. chlorine or bromine. Most preferred are dialkyldimethyl ammonium salts represented by R¹⁴₂N+(CH₃)₂Y—, where each R¹⁴ is an alkyl group containing 12-30 carbon atoms, or alkyl groups derived from tallow, coconut oil, or soy and Y is as defined above. Monoalkyltrimethyl ammonium salts can also be employed, and are represented by R¹⁴N⁺(CH₃)₃Y⁻ where R¹⁴ and Y are as defined above.

Some representative quaternary ammonium salts are dodecyltrimethyl ammonium bromide (DTAB), didodecyldimethyl ammonium bromide, dihexadecyldimethyl ammonium chloride, dihexadecyldimethyl ammonium bromide, dioctadecyldimethyl ammonium chloride, dieicosyldimethyl ammonium chloride, didocosyldimethyl ammonium chloride, dicoconutdimethyl ammonium chloride, ditallowdimethyl ammonium chloride, and ditallowdimethyl ammonium bromide. These and other quaternary ammonium salts are commercially available under tradenames such as ADOGEN, ARQUAD, TOMAH and VARIQUAT.

Among the various types of anionic surfactants which can be used are sulfonic acids and their salt derivatives; alkali metal sulfosuccinates; sulfonate glyceryl esters of fatty acids such as sulfonate monoglycerides of coconut oil acids; salts of sulfonate monovalent alcohol esters such as sodium oleyl isothionate; amides of amino sulfonic acids such as the sodium salt of oleyl methyl tauride; sulfonate products of fatty acid nitriles such as palmitonitrile sulfonate; sulfonate aromatic hydrocarbons such as sodium alphanaphthalene monosulfonate; condensation products of naphthalene sulfonic acids with formaldehyde; sodium octahydro anthracene sulfonate; alkali metal alkyl sulfates such as sodium lauryl (dodecyl) sulfate (SDS); ether sulfates having alkyl groups of eight or more carbon atoms; and alkylaryl sulfonates having one or more alkyl groups of eight or more carbon atoms.

Some examples of commercial anionic surfactants useful in this invention include triethanolamine linear alkyl sulfonate sold under the tradename BIO-SOFT N-300 by the Stepan Company, Northfield, Ill.; sulfates sold under the tradename POLYSTEP by the Stepan Company; and sodium n-hexadecyl diphenyloxide disulfonate sold under the tradename DOWFAX 8390 by The Dow Chemical Company, Midland, Mich.

Amphoteric surfactants can also be used which generally comprise surfactant compositions such as alkyl betaines, alkylamido betaines, and amine oxides, specific examples of which are known in the art.

Optional ingredients may also be included in the emulsions of foam control compositions according to the invention. These are well known in the art and include for example thickeners, preservatives, pH stabilizers etc. Suitable examples of thickeners include sodium alginate, gum arabic, polyoxyethylene, guar gum, hydroxypropyl guar gum, ethoxylated alcohols, such as laureth-4 or polyethylene glycol 400, cellulose derivatives exemplified by methylcellulose, methylhydroxypropylcellulose, hydroxypropylcellulose, polypropylhydroxyethylcellulose, starch, and starch derivatives exemplified by hydroxyethylamylose and starch amylose, locust bean gum, electrolytes exemplified by sodium chloride and ammonium chloride, and saccharides such as fructose and glucose, and derivatives of saccharides such as PEG-120 methyl glucose diolate or mixtures of 2 or more of these and acrylic polymer thickeners (e.g. those sold under the tradenames PEMULEN and CARBOPOL). Suitable preservatives include the parabens, BHT, BHA and other well known ingredients such as isothiazoline or mixtures of organic acids like benzoic acid and sorbic acid.

The oil-in-water silicone emulsion composition of the present invention can be made by using an emulsifying device such as, for example, a homomixer, homogenizer, colloid mill, Combi mixer, inline-type continuous emulsifying device, vacuum emulsifying device, ultrasound emulsifying device, continuous mixing apparatus, and so forth. Viewed from the perspective of the stability upon dilution with water, the average particle size of the emulsion particles is preferably not more than 50 μm and alternatively not more than 30 μm. The average particle size of the emulsion particles can be measured, for example, by a dynamic light scattering procedure using a submicron particle analyzer (Coulter Model N4 MD from Coulter Electronics, Inc.) at 25° C. and monodispersion mode analysis.

Where emulsification is intended, it is preferred to introduce another optional ingredient. This may be included with the ingredients in the combination of (A), (B), and (C) or may be added immediately prior to the emulsification process. This optional ingredient is a silicone resin having M and Q units and optionally D and/or T units. The silicone resin may be for example an organosilicon compound with the average units of the general formula R¹⁵_{d}SiZ_{4-d} in which R¹⁵ is a monovalent hydrocarbon group having 1 to 5 carbon atoms, Z is a hydrolyzable group and d has an average value of one or less. Examples are alkyl polysilicate wherein the alkyl group has one to five carbon atoms, such as methyl polysilicate, ethyl polysilicate and propyl polysilicate.

Alternatively it is a resin which only has M and Q units and is also known as MQ resin. The preferred MQ resins are those consisting essentially of (CH₃)₃SiO_{1/2} units and SiO_{4/2} units wherein the ratio of (CH₃)₃SiO_{1/2} units to SiO_{4/2} units is from 0.4:1 to 1.2:1, alternatively 0.75:1 to 1:1 or a condensate of said MQ resin with the organosilicon compound described above. These silicone resins have been known and described in a number of publications and are commercially available.

The main benefit for the use of the silicone resin is that it has surprisingly been found that the use of small amounts of such resin substantially facilitates the emulsification of the foam control compositions according to this invention. Indeed addition of as little as up to 0.5% of a silicone resin by weight, based on the weight of the foam control composition will enable foam control agents with high viscosity or high molecular weight branched or cross-linked polyorganosiloxanes to be readily emulsified by mechanical means, which would otherwise be extremely difficult. Also it was found that the addition of such small amounts of silicone resin provides emulsions with smaller particle size for identical emulsification processes. This of course will lead to greater stability of the emulsion. Larger amounts than 0.5% may also be added, but do not provide any further benefit to the emulsification step of the process according to the invention.

The foam control compositions can be used as any kind of foam control compositions, i.e. as defoaming agents and/or antifoaming agents. Defoaming agents are generally considered as foam reducers whereas antifoaming agents are generally considered as foam preventers. The foam control compositions of the present invention find utility in various media such as inks, coatings, paints, detergents, including textile washing, laundry and auto dish washing, black liquor, and pulp and paper manufacture, waste water treatment, textile dyeing processes, the scrubbing of natural gas.

In addition, the silicone foam control composition may incorporate other components on an optional basis as appropriate, for example, a thickener, penetrating agent, antistatic agent, inorganic powder, preservative, silane coupling agent, pH adjusting agent, ultraviolet absorber, tin-free curing catalyst, water-soluble resin, organic resin emulsion, pigment, dye, and so forth.

Optionally, an amine compound (E) may also be added as a pH adjusting agent. The amine compound can be exemplified by diethylamine, ethylenediamine, butylamine, hexylamine, morpholine, monoethanolamine, triethylamine, triethanolamine, dipropanolamine, and 2-amino-2-methyl-2-propanol, wherein diethylamine is preferred among the preceding. When added, component (E) is used in amounts in the range from 0.01 to 5% weight basis, alternatively in the range from 0.1 to 2% weight basis.

### EXAMPLES

The invention having been generally described above, may be better understood by reference to the examples described below. The following examples represent specific but non-limiting embodiments of the present invention.

Comparisons 1 and 2 are baseline comparisons wherein a foam control composition is prepared that does not contain component (C).

### Comparison 1

In Step 1, added to a vessel were 70 parts of an inert fluid trimethyl-terminated polydimethylsiloxane as component (D) having a viscosity of 1000 mPa-s at 25° C., commercially available from Dow Corning Corp. (Midland, Mich.), 3 parts Sipernat D10 as component (A), and 27 parts of a hydroxy terminated polydimethylsiloxane having a viscosity of 15,000 mPa-s at 25° C., commercially available from Dow Corning Corp. (Midland, Mich.) as component (B). The contents were mixed to obtain a concentrate dispersion. In step 2, 30 parts of the concentrate dispersion were combined with 7 parts silicone polyether produced in accordance with the method described in US2003/0013808 for CP1 and 63 parts of a copolymer of polyoxyethylene and polyoxypropylene glycol identified as G-3000 from Sanyo Chemical Industry, and mixed to obtain a dispersion. In step 3, 30 parts of the dispersion was diluted with 70 parts water and mixed to obtain an emulsion to be tested for antifoam performance. The viscosity was 1300 mPa-s.

### Comparison 2

The procedure of Comparison 1 was repeated except that the 3 parts of hydrophobic silica (A) was replaced with an equal amount of a hydrophilic silica (A) as Aerosil 200 and the 70 parts of the inert fluid (D) was replaced with an equal amount of component (B). The viscosity was 45,000 mPa-S and is non-flowable due to an increase in its thixotropic nature.

### Comparison 3

The procedure of Comparison 1 was repeated except that in Step 1, two parts of the inert fluid (D) was replaced with two parts of an aminoxy group-containing organosilicon compound as component (C) given by the structure:

Me₃SiO(Me₂SiO)₃(MeSi(ONEt₂)O)₄SiMe₃.

Further, the concentrate dispersion of Step 1 was stored at room temperature for five days for cross-linking to occur before moving to Step 2. An elastomer was formed, which could not be made into an emulsion.

### Example 1

The procedure of Comparison 1 was repeated except that in Step 1 one part of the component (D) was replaced with one part of an aminoxy group-containing organosilicon compound as component (C) given by the structure:

Me₃SiO(Me₂SiO)₃(MeSi(ONEt₂)O)₄SiMe₃.

Further, the concentrate dispersion of Step 1 was stored at room temperature for five days for cross-linking to occur before moving to Step 2. In this example, cross-linking occurred before an emulsion was formed. The viscosity was 35,000 mPa-S.

### Example 2

The procedure of Comparison 1 was repeated except that in Step 1 one part of the component (D) was replaced with one part of an aminoxy group-containing organosilicon compound as component (C) given by the structure:

Me₃SiO(Me₂SiO)₃(MeSi(ONEt₂)O)₄SiMe₃.

Further, the concentrate dispersion obtained in Step 1 was immediately moved to Step 2, followed by Step 3.

### Example 3

The procedure of Comparison 1 was repeated except that in Step 1 two parts of the component (D) was replaced with two parts of an aminoxy group-containing organosilicon compound as component (C) given by the structure:

Me₃SiO(Me₂SiO)₃(MeSi(ONEt₂)O)₄SiMe₃

Further, the concentrate dispersion obtained in Step 1 was immediately moved to Step 2, followed by Step 3.

### Example 4

This example is similar to both Comparison 1 and Example 1.

In Step 1, added to a vessel were 98 parts of a hydroxy terminated polydimethylsiloxane as component (B), 3 parts of a hydrophilic silica as component (A), and 1 part of an aminoxy group-containing organosilicon compound as component (C) given by the structure:

Me₃SiO(Me₂SiO)₃(MeSi(ONEt₂)O)₄SiMe₃.

Further, the concentrate dispersion of Step 1 was stored at room temperature for five days for cross-linking to occur before moving to Step 2. In this example, cross-linking occurred before an emulsion was formed. The viscosity was 81,300 mPa-S.

### Example 5

The procedure of Comparison 1 is repeated except that in Step 1 one part of the component (D) is replaced with one part of an aminoxy group-containing organosilicon compound as component (C) given by the structure:

Me₃SiO(Me₂SiO)₅(MeSi(ONEt₂)O)₆SiMe₃.

### Example 6

The procedure of Comparison 1 is repeated except that in Step 1 one part of the component (D) is replaced with one part of an aminoxy group-containing organosilicon compound as component (C) given by the structure:

n-BuSi(ONEt₂)₃

### Example 7

The procedure of Comparison 1 is repeated except that in Step 1 one part of the component (D) is replaced with one part of an aminoxy group-containing organosilicon compound as component (C) given by the structure:

ONEt₂Me₂SiO(Me₂SiO)₅(MeSi(ONEt₂)O)₃SiMe₂ONEt₂.

### Example 8

The procedure of Comparison 1 is repeated except that in Step 1 one part of the component (D) is replaced with one part of an aminoxy group-containing organosilicon compound as component (C) given by the structure:

ONEt₂Me₂SiO(MeSi(ONEt₂)O)₅SiMe₂ONEt₂.

### Evaluation

Comparisons 1-3 and Examples 1-4 were evaluated in an Antifoam test. The results are tabulated in Table 1.

Antifoam performance was tested in a foam cell using a foaming solution based on 0.1 wt % dilution of Tween 80. In this test, 500 ml of the foaming solution is preheated at 80° C. and added to a graduated and thermostatically controlled glass cylinder having an inner diameter of 5 cm. This foamable liquid was circulated through a circulation pipe at a temperature adjusted to 80° C. The circulation flow rate is controlled using an inverter to adjust the flow rate at 2 liter/min. When the foam height of 38 cm is reached, 0.10 ml of emulsion of the tested foam control composition is injected in the liquid jet. The evolution of the foam height was monitored and recorded. The foam height was measured in cm over a time span of 10 minutes. The foam height is recorded in Table 1.

TABLE 1

| | Foam Level (cm) | | | | | | | | | |
|---|---|---|---|---|---|---|---|---|---|---|
| Circulation Time in | 1 | 2 | 3 | 4 | 5 | 6 | 7 | 8 | 9 | 10 |
| Minutes | | | | | | | | | | |
| Without Antifoam | 38 | 38 | 38 | 38 | 38 | 38 | 38 | 38 | 38 | 38 |
| Comparison 1 | 37 | 38 | 38 | 38 | 38 | 38 | 38 | 38 | 38 | 38 |
| Comparison 2 | 27 | 38 | 38 | 38 | 38 | 38 | 38 | 38 | 38 | 38 |
| Comparison 3 (no | — | — | — | — | — | — | — | — | — | — |
| emulsification could | | | | | | | | | | |
| occur and thus no | | | | | | | | | | |
| foam test was run. | | | | | | | | | | |
| Example 1 (crosslinking | 24 | 27 | 28 | 28 | 30 | 31 | 32 | 32 | 33 | 34 |
| before emulsification) | | | | | | | | | | |
| Example 2 (crosslinking | 33 | 35 | 38 | 38 | 38 | 38 | 38 | 38 | 38 | 38 |
| within the emulsion | | | | | | | | | | |
| particles) | | | | | | | | | | |
| Example 3 (crosslinking | 25 | 26 | 27 | 28 | 29 | 30 | 31 | 31 | 32 | 32 |
| within the emulsion | | | | | | | | | | |
| particles) | | | | | | | | | | |
| Example 4 (crosslinking | 22 | 25 | 29 | 29 | 30 | 27 | 27 | 28 | 28 | 28 |
| before emulsification) | | | | | | | | | | |

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

1. A silicone foam control composition comprising;
(A) a finely divided filler, and
(B) an organosilicon compound having at least two silicon-bonded hydroxy groups in each molecule,
(C) an organosilicon compound having at least two silicon-bonded aminoxy groups in each molecule wherein the molar ratio of silanol groups in (B) to aminoxy groups in (C) is 100:1 to 1:100, and optionally
(D) an inert fluid,
wherein at least (B) and (C) react so that the silicone foam control composition has a viscosity of from 1,000 mPa·s to 1,000,000 mPa·s at 25° C.

2. A silicone foam control composition comprising:
(A) a finely divided filler, and
(B) an organosilicon compound having at least two silicon-bonded hydroxy groups in each molecule capable of reaction with,
(C) an organosilicon compound having at least two silicon-bonded aminoxy groups in each molecule wherein the molar ratio of (B):(C) is 100:1 to 1:100, and optionally
(D) an inert fluid,
wherein the silicone foam control composition has a viscosity of from 1,000 mPa·s to 1,000,000 mPa·s at 25° C.

3. The silicone foam control composition of claim 1, wherein the finely divided filler (A) is a hydrophilic silica or a hydrophobic silica having an average particle size of from 0.1 to 50 μm.

4. The silicone foam control composition according to claim 1, wherein the organosilicon compound (B) is selected from the general formulae (Ia) or (Ib) or a mixture thereof: 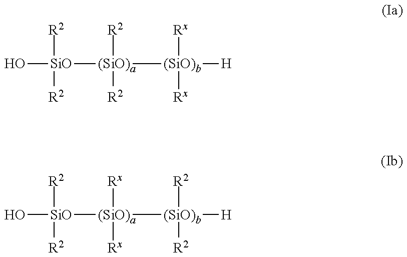
wherein each R² is independently selected from a hydroxy group, an alkyl group having from 1 to 18 carbon atoms, an alkenyl group having from 2 to 18 carbon atoms, an alkynyl group having from 2 to 18 carbon atoms, an aryl group having from 6 to 10 carbon atoms, an alkoxy group of the formula —OR³ wherein R³ is an alkyl group having from 1 to 18 carbon atoms, an X-Ph group wherein X denotes —R^{y}—, —R^{y}—O—, —R^{y}—O—R^{y}— or —COO— wherein R^{y} is an alkylene group containing from 1 to 18 carbon atoms, and -Ph is a phenyl group or a phenyl group substituted with one or more methyl, methoxy, hydroxy, or chloro group, and a group of the formula —R^{a}O(C₂H₄O)ₓ—(C₃H₆O)_{y}—(C₄H₈O)_{z}R^{b} wherein R^{a} is an alkylene group containing from 1 to 18 carbon atoms, R^{b} is a hydrogen atom, an alkyl group containing from 1 to 6 carbon atoms, or an acyl group containing from 1 to 6 carbon atoms, x is 0-50, y is 0-50, and z is 0-20, with the proviso that x+y+z is ≧1, and wherein R^{x} is independently selected from a hydroxyl group, an alkyl group having from 1 to 18 carbon atoms, or a group of the general formula (II) 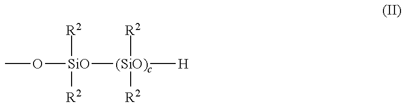
wherein R² is as defined above and a, b, and c have a value of zero or greater, provided that at least one of a and b is ≧1 and the total of a+b+c is from 1 to 10,000.

5. The silicone foam control composition according to claim 1, wherein the aminoxy group-containing organosilicon compound (C) is selected from the general formulae (III) or (IV) or a mixture thereof
R⁶₄₋ₘSi(ONR⁷2)ₘ (III)
R⁹R⁸₂SiO(R⁹₂SiO)ₙ(R⁸₂SiO)_{m′}SiR⁸₂R⁹ (IV)
wherein R⁶ is selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and —ONR⁷₂, wherein R⁷ is independently an alkyl group having from 1 to 4 carbon atoms and m is from 1 to 4; each R⁸ is independently selected from an alkyl group having from 1 to 18 carbon atoms, an alkenyl group having from 2 to 18 carbon atoms, an alkynyl group having from 2 to 18 carbon atoms, and an aryl group having from 6 to 10 carbon atoms, each R⁹ is independently selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and an aminoxy group of the formula —ONR¹⁰₂, with the proviso that at least two R⁹ groups are aminoxy groups, and R¹⁰ is independently an alkyl group having from 1 to 4 carbon atoms, n is ≧1, and m′ is ≧0.

6. The silicone foam control composition according to claim 1, wherein the inert fluid (D) is utilized and is at least one of an inert organopolysiloxane fluid that is a trialkylsilyl terminated polydialkylsiloxane wherein the alkyl groups independently have from 1 to 18 carbon atoms and a viscosity of from 0.65 to 10000 mPa·s at 25° C. or an organic fluid.

7. An oil-in-water silicone emulsion composition comprising water and the silicone foam control composition of claim 1 dispersed therein.

8. The oil-in-water silicone emulsion composition of claim 7, where the average particle size of the emulsion particles is not more than 50 μm.

9. A process for making a foam control composition comprising the steps of mixing (A) a finely divided filler, and (B) an organosilicon compound having at least two silicon-bonded hydroxy groups in each molecule, (C) an organosilicon compound having at least two silicon-bonded aminoxy groups in each molecule wherein the molar ratio of silanol groups in (B) to aminoxy groups in (C) is 100:1 to 1:100, and optionally (D) an inert fluid, and allowing at least (B) and (C) to react so the silicone foam control composition has a viscosity of from 1,000 mPa·s to 1,000,000 mPa·s at 25° C.

10. A process for making a silicone foam control composition which comprises the steps of mixing (A) a finely divided filler and (B) a organosilicon compound having at least two silicon-bonded hydroxy groups, capable of reaction with (C) an organosilicon compound having at least two silicon-bonded aminoxy groups in each molecule wherein the molar ratio of (B):(C) is 100:1 to 1:100, and optionally (D) an inert fluid, wherein the silicone foam control composition has a viscosity of from 1,000 mPa·s to 1,000,000 mPa·s at 25° C.

11. The process for making the silicone foam control composition of claim 9, wherein the finely divided filler (A) is a hydrophilic silica or a hydrophobic silica having an average particle size of from 0.1 to 50 μm.

12. The process for making the silicone foam control composition according to claim 9, wherein the organosilicon compound (B) is selected from the general formulae (Ia) or (Ib) or a mixture thereof 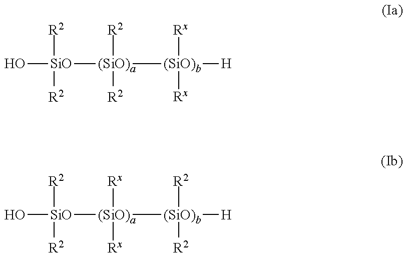
wherein each R² is independently selected from a hydroxy group, an alkyl group having from 1 to 18 carbon atoms, an alkenyl group having from 2 to 18 carbon atoms, an alkynyl group having from 2 to 18 carbon atoms, an aryl group having from 6 to 10 carbon atoms, an alkoxy group of the formula —OR³ wherein R³ is an alkyl group having from 1 to 18 carbon atoms, an X-Ph group wherein X denotes —R^{y}—, —R^{y}—O—, —R^{y}—O—R^{y}— or —COO— wherein —R^{y}— is an alkylene group, containing from 1 to 18 carbon atoms, and -Ph is a phenyl group or a phenyl group substituted with one or more methyl, methoxy, hydroxy, or chloro group, and a group of the formula —R^{a}O(C₂H₄O)ₓ—(C₃H₆O)_{y}—(C₄H₈O)_{z}R^{b} wherein R^{a} is an alkylene group containing from 1 to 18 carbon atoms, R^{b} is a hydrogen atom, an alkyl group containing from 1 to 6 carbon atoms, or an acyl group containing from 1 to 6 carbon atoms, x is 0-50, y is 0-50, and z is 0-20, with the proviso that x+y+z is ≧1,
wherein R^{x} is independently selected from a hydroxyl group, an alkyl group having from 1 to 18 carbon atoms, or a group of the general formula (II) 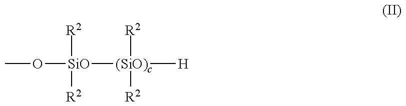
wherein R² is as defined above and a, b, and c have a value of zero or an integer, provided that at least one of a and b is ≧1 and the total of a+b+c is from 1 to 10,000.

13. The process for making the silicone foam control composition according to claim 9, wherein the aminoxy group-containing organosilicon compound (C) is selected from the general formulae (III) or (IV) or a mixture thereof
R⁶₄₋ₘSi(ONR⁷₂)ₘ (III)
R⁹R⁸₂SiO(R⁹₂SiO)ₙ(R⁸₂SiO)_{m′}SiR⁸₂R⁹ (IV)
wherein R⁶ is selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and —ONR⁷₂, wherein R⁷ is independently an alkyl group having from 1 to 4 carbon atoms and m is from 1 to 4; each R⁸ is independently selected from an alkyl group having from 1 to 18 carbon atoms, an alkenyl group having from 2 to 18 carbon atoms, an alkynyl group having from 2 to 18 carbon atoms, and an aryl group having from 6 to 10 carbon atoms, each R⁹ is independently selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, an aminoxy group of the formula —ONR¹⁰₂, with the proviso that at least two R⁹ groups are aminoxy groups, and R¹⁰ is independently an alkyl group having from 1 to 4 carbon atoms, n is ≧1, and m′ is ≧0.

14. The process for making the silicone foam control composition according to claim 9, wherein the inert fluid (D) is utilized and is at least one of an inert organopolysiloxane fluid that is a trialkylsilyl terminated polydialkylsiloxane wherein the alkyl groups independently have from 1 to 18 carbon atoms and a viscosity of from 0.65 to 10000 mPa-S at 25° C. or an organic fluid.

15. A method for controlling foam in an aqueous media comprising adding a sufficient amount of the silicone foam control composition as described in claim 1 to the aqueous media.

16. The silicone foam control composition of claim 2, wherein the finely divided filler (A) is a hydrophilic silica or a hydrophobic silica having an average particle size of from 0.1 to 50 μm.

17. The silicone foam control composition according to claim 2, wherein the organosilicon compound (B) is selected from the general formulae (Ia) or (Ib) or a mixture thereof: 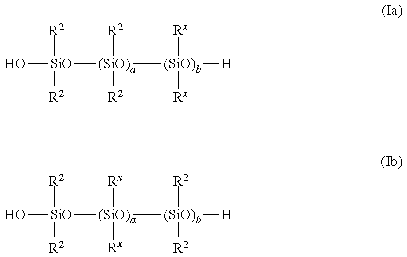
wherein each R² is independently selected from a hydroxy group, an alkyl group having from 1 to 18 carbon atoms, an alkenyl group having from 2 to 18 carbon atoms, an alkynyl group having from 2 to 18 carbon atoms, an aryl group having from 6 to 10 carbon atoms, an alkoxy group of the formula —OR³ wherein R³ is an alkyl group having from 1 to 18 carbon atoms, an X-Ph group wherein X denotes —R^{y}—, —R^{y}—O—, —R^{y}—O—R^{y}— or —COO— wherein R^{y} is an alkylene group containing from 1 to 18 carbon atoms, and -Ph is a phenyl group or a phenyl group substituted with one or more methyl, methoxy, hydroxy, or chloro group, and a group of the formula —R^{a}O(C₂H₄O)ₓ—(C₃H₆O)_{y}—(C₄H₈O)_{z}R^{b} wherein R^{a} is an alkylene group containing from 1 to 18 carbon atoms, R^{b} is a hydrogen atom, an alkyl group containing from 1 to 6 carbon atoms, or an acyl group containing from 1 to 6 carbon atoms, x is 0-50, y is 0-50, and z is 0-20, with the proviso that x+y+z is ≧1, and wherein R^{x} is independently selected from a hydroxyl group, an alkyl group having from 1 to 18 carbon atoms, or a group of the general formula (II) 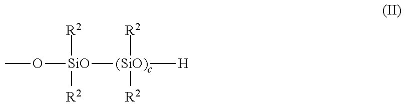
wherein R² is as defined above and a, b, and c have a value of zero or greater, provided that at least one of a and b is ≧1 and the total of a+b+c is from 1 to 10,000.

18. The silicone foam control composition according to claim 2, wherein the aminoxy group-containing organosilicon compound (C) is selected from the general formulae (III) or (IV) or a mixture thereof
R⁶₄₋ₘSi(ONR⁷2)ₘ (III)
R⁹R⁸₂SiO(R⁹₂SiO)ₙ(R⁸₂SiO)_{m′}SiR⁸₂R⁹ (IV)
wherein R⁶ is selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and —ONR⁷₂, wherein R⁷ is independently an alkyl group having from 1 to 4 carbon atoms and m is from 1 to 4; each R⁸ is independently selected from an alkyl group having from 1 to 18 carbon atoms, an alkenyl group having from 2 to 18 carbon atoms, an alkynyl group having from 2 to 18 carbon atoms, and an aryl group having from 6 to 10 carbon atoms, each R⁹ is independently selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and an aminoxy group of the formula —ONR¹⁰₂, with the proviso that at least two R⁹ groups are aminoxy groups, and R¹⁰ is independently an alkyl group having from 1 to 4 carbon atoms, n is ≧1, and m′ is ≧0.

19. The silicone foam control composition according to claim 2, wherein the inert fluid (D) is utilized and is at least one of an inert organopolysiloxane fluid that is a trialkylsilyl terminated polydialkylsiloxane wherein the alkyl groups independently have from 1 to 18 carbon atoms and a viscosity of from 0.65 to 10000 mPa·s at 25° C. or an organic fluid.

20. An oil-in-water silicone emulsion composition comprising water and the silicone foam control composition of claim 2 dispersed therein.

21. The oil-in-water silicone emulsion composition of claim 20, where the average particle size of the emulsion particles is not more than 50 μm.

22. The process for making the silicone foam control composition of claim 10, wherein the finely divided filler (A) is a hydrophilic silica or a hydrophobic silica having an average particle size of from 0.1 to 50 μm.

23. The process for making the silicone foam control composition according to claim 10, wherein the organosilicon compound (B) is selected from the general formulae (Ia) or (Ib) or a mixture thereof 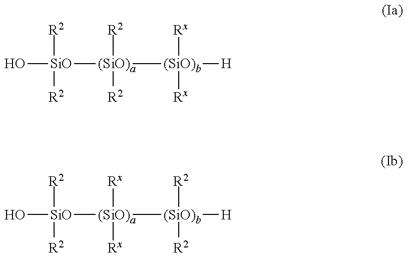
wherein each R² is independently selected from a hydroxy group, an alkyl group having from 1 to 18 carbon atoms, an alkenyl group having from 2 to 18 carbon atoms, an alkynyl group having from 2 to 18 carbon atoms, an aryl group having from 6 to 10 carbon atoms, an alkoxy group of the formula —OR³ wherein R³ is an alkyl group having from 1 to 18 carbon atoms, an X-Ph group wherein X denotes —R^{y}—, —R^{y}—O—, —R^{y}—O—R^{y}— or —COO— wherein —R^{y}— is an alkylene group, containing from 1 to 18 carbon atoms, and -Ph is a phenyl group or a phenyl group substituted with one or more methyl, methoxy, hydroxy, or chloro group, and a group of the formula —R^{a}O(C₂H₄O)ₓ—(C₃H₆O)_{y}—(C₄H₈O)_{z}R^{b} wherein R^{a} is an alkylene group containing from 1 to 18 carbon atoms, R^{b} is a hydrogen atom, an alkyl group containing from 1 to 6 carbon atoms, or an acyl group containing from 1 to 6 carbon atoms, x is 0-50, y is 0-50, and z is 0-20, with the proviso that x+y+z is ≧1,
wherein R^{x} is independently selected from a hydroxyl group, an alkyl group having from 1 to 18 carbon atoms, or a group of the general formula (II) 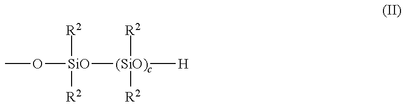
wherein R² is as defined above and a, b, and c have a value of zero or an integer, provided that at least one of a and b is ≧1 and the total of a+b+c is from 1 to 10,000.

24. The process for making the silicone foam control composition according to claim 10, wherein the aminoxy group-containing organosilicon compound (C) is selected from the general formulae (III) or (IV) or a mixture thereof
R⁶₄₋ₘSi(ONR⁷2)ₘ (III)
R⁹R⁸₂SiO(R⁹₂SiO)ₙ(R⁸₂SiO)_{m′}SiR⁸₂R⁹ (IV)
wherein R⁶ is selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, and —ONR⁷₂, wherein R⁷ is independently an alkyl group having from 1 to 4 carbon atoms and m is from 1 to 4; each R⁸ is independently selected from an alkyl group having from 1 to 18 carbon atoms, an alkenyl group having from 2 to 18 carbon atoms, an alkynyl group having from 2 to 18 carbon atoms, and an aryl group having from 6 to 10 carbon atoms, each R⁹ is independently selected from an alkyl group having from 1 to 18 carbon atoms, an alkenyl group having from 2 to 18 carbon atoms, an alkynyl group having from 2 to 18 carbon atoms, an aryl group having from 6 to 10 carbon atoms, an aminoxy group of the formula —ONR¹⁰₂, with the proviso that at least two R⁹ groups are aminoxy groups, and R¹⁰ is independently an alkyl group having from 1 to 4 carbon atoms, n is ≧1, and m′ is ≧0.

25. The process for making the silicone foam control composition according to claim 10, wherein the inert fluid (D) is utilized and is at least one of an inert organopolysiloxane fluid that is a trialkylsilyl terminated polydialkylsiloxane wherein the alkyl groups independently have from 1 to 18 carbon atoms and a viscosity of from 0.65 to 10000 mPa·s at 25° C. or an organic fluid.

26. A method for controlling foam in an aqueous media comprising adding a sufficient amount of the silicone foam control composition as described in claim 2 to the aqueous media.

27. A method for controlling foam in an aqueous media comprising adding a sufficient amount of the oil-in-water silicone emulsion composition as described in claim 7 to the aqueous media.

28. A method for controlling foam in an aqueous media comprising adding a sufficient amount of the oil-in-water silicone emulsion composition as described in claim 20 to the aqueous media.
